(19) United States
(12) Patent Application Publication
(10) Pub. No.: US 2018/0156957 A1
(43) Pub. Date: Jun. 7, 2018

(54) LIGHTGUIDE INCLUDING LAMINATED EXTRACTION FILM

(71) Applicant: 3M INNOVATIVE PROPERTIES COMPANY, St. Paul, MN (US)

(72) Inventors: Jeremy K. Larsen, Farmington, MN (US); Bing Hao, Woodbury, MN (US); David A. Ender, New Richmond, WI (US); Tao Liu, Woodbury, MN (US); Olester Benson, Woodbury, MN (US); Joseph V. Crimando, St. Paul, MN (US); Raveesh K. Shenoy, Minneapolis, MN (US); John C. Schultz, Afton, MN (US)

(21) Appl. No.: 15/565,199

(22) PCT Filed: Mar. 28, 2016
(86) PCT No.: PCT/US2016/024454

§ 371 Date: Oct. 9, 2017

Related U.S. Application Data
(60) Provisional application No. 62/145,721, filed on Apr. 10, 2015.

(51) Int. Cl. F21V 8/00

(52) U.S. Cl. CPC G02B 6/006; G02B 6/0061; G02B 6/0055

(57) ABSTRACT

Lightguides and methods for making and using the same are disclosed. A structured layer is provided with light extractors formed on a structured surface thereof. In some cases, the structured layer is removably laminated onto a substrate to provide uniform light extraction. In some cases, indicia are cut out of the structured layer and laminated onto the substrate. In some cases, the structured surface of the structured layer is selectively filled to form a pattern for light extraction. In some cases, a tool for producing a structured layer has a region of structures selectively filled to form a pattern for light extraction on the produced structured layer.

### TECHNICAL FIELD

The present disclosure relates to lightguides including laminated extraction film, and the methods of producing and using the same.

### BACKGROUND

Lightguides can be used to transport, distribute, direct, and/or control the extraction of light over an output area. Some lightguides can include light extractors which direct, divert, or reflect light such that the light can pass out of the lightguide and in some cases be viewed by a viewer. Some lightguides have been described in U.S. Pat. No. 5,905,826 (Benson et al.), U.S. Pat. No. 5,995,690 (Kotz et al.), U.S. Pat. No. 8,615,151 (Rinko), EP 2374608 A2 (Greener et al.), US Patent Application Publication No. 20130063968 (Neugebauer et al.), US Patent Application Publication No. 20130170218 (Wolk et al.), US Patent Application Publication No. 20130201720 (Sherman et al.), and US Patent Application Publication No. 20130235614 (Wolk et al).

### SUMMARY

In one aspect, the present disclosure relates to a lightguide. The lightguide includes a substrate having a first major surface and a second major surface opposite the first major surface. The substrate includes one or more edges being configured to allow light to be incident into the substrate and propagate along the substrate. The first and second major surfaces are capable of confining the light in the substrate primarily by total internal reflection. One or more structured layers are laminated on at least one of the first and second major surfaces of the substrate. The one or more structured layers each include one or more light extractors being configured to direct the light out of the lightguide from an emitting surface thereof. At least one of the one or more structured layers are removable from and repositionable on the substrate.

In another aspect, the present disclosure relates to a lightguide including a structured layer having a structured surface and an array of light extractors formed on the structured surface to direct light out of the lightguide from an emitting surface thereof. The structured surface of the structured layer includes a first region and an adjacent second region. The light extractors in the first region are filled with an optical material to adjust light extraction in the first region compared to that in the second region when the lightguide is in an on state.

In yet another aspect, the present disclosure relates to a method of making a lightguide. The method includes providing a substrate having a first major surface and a second major surface opposite the first major surface. The substrate includes one or more edges being configured to allow light to be incident into the substrate and propagate along the substrate. The first and second major surfaces are capable of confining the light in the substrate primarily by total internal reflection. The method further includes laminating one or more structured layers onto at least one of the first and second major surfaces of the substrate. The one or more structured layers each include one or more light extractors being configured to direct the light out of the substrate from an emitting surface thereof. At least one of the one or more structured layers is removable from and repositionable on the substrate.

In another aspect, the present disclosure relates to a method including providing one or more structured layers where the structured layers each include an array of light extractors formed on a structured surface thereof, cutting one or more indicia out of the one or more structured layers, and laminating the one or more indicia onto a major surface of a substrate. The one or more indicia are configured to extract light that is otherwise confined in and propagates in the substrate.

In yet another aspect, the present disclosure relates to a method of producing a lightguide including providing a structured layer including an array of light extractors formed on a structured surface thereof. The method further includes selectively filling a first group of light extractors in a first region of the structured surface with an optical material to modify light extraction in the first region when the lightguide is in an on state.

In yet another aspect, the present disclosure relates to a method including providing a tool including an array of microstructures on a major surface thereof, selectively filling a first region of the major surface of the tool with a blocking material, and providing a film forming composition on the major surface of the tool to form a structured layer. An array of light extractors are formed on a structured surface of the structured layer except for a first region thereof corresponding to the first region of the tool. The method further includes removing the structured layer from the tool. The structured layer has the structured surface including the light extractors.

### BRIEF DESCRIPTION OF THE DRAWINGS

FIG. 1A is a cross-sectional side view of a lightguide including a substrate and a structured layer before lamination, according to one embodiment.

FIG. 1B is a cross-sectional side view of the lightguide of FIG. 1A after lamination.

FIG. 2A is a side perspective view of a light extractor, according to one embodiment.

FIG. 2B is a side perspective view of a light extractor, according to another embodiment.

FIG. 2C is a side perspective view of a light extractor, according to another embodiment.

FIG. 2D is a side perspective view of a light extractor, according to another embodiment.

FIG. 2E is a side perspective view of a light extractor, according to another embodiment.

FIG. 2F is a side perspective view of a light extractor, according to another embodiment.

FIG. 2G is a side perspective view of a light extractor, according to another embodiment.

FIG. 2H is a top plan view of the light extractor of FIG. 2G.

FIG. 3 is a top plan view of a lightguide including receiving light from edge locations and indicia laminated thereon, according to one embodiment.

FIG. 4A is a top plan view of a structured film, according to one embodiment.

FIG. 4B is a cross-sectional side view of the structured film of FIG. 4A.

FIG. 5 illustrates a process of forming a structured film, according to one embodiment.

FIG. 6 is a cross-sectional side view of a lightguide including multiple laminated structured layers, according to one embodiment.

### DETAILED DESCRIPTION

Lightguides and methods for making and using the same are disclosed. A structured layer is provided with one or more light extractors formed on a structured surface thereof. In some cases, the structured layer is laminated onto a substrate to provide uniform light extraction. In some cases, indicia are cut out of the structured layer and laminated onto the substrate where the orientation of the light extractors in the indicia is adjustable. In some cases, the structured surface of the structured layer is selectively filled to form a pattern for light extraction. In some cases, a tool for producing the structured layer has a region of structures selectively filled to form a pattern for light extraction on the produced structured layer.

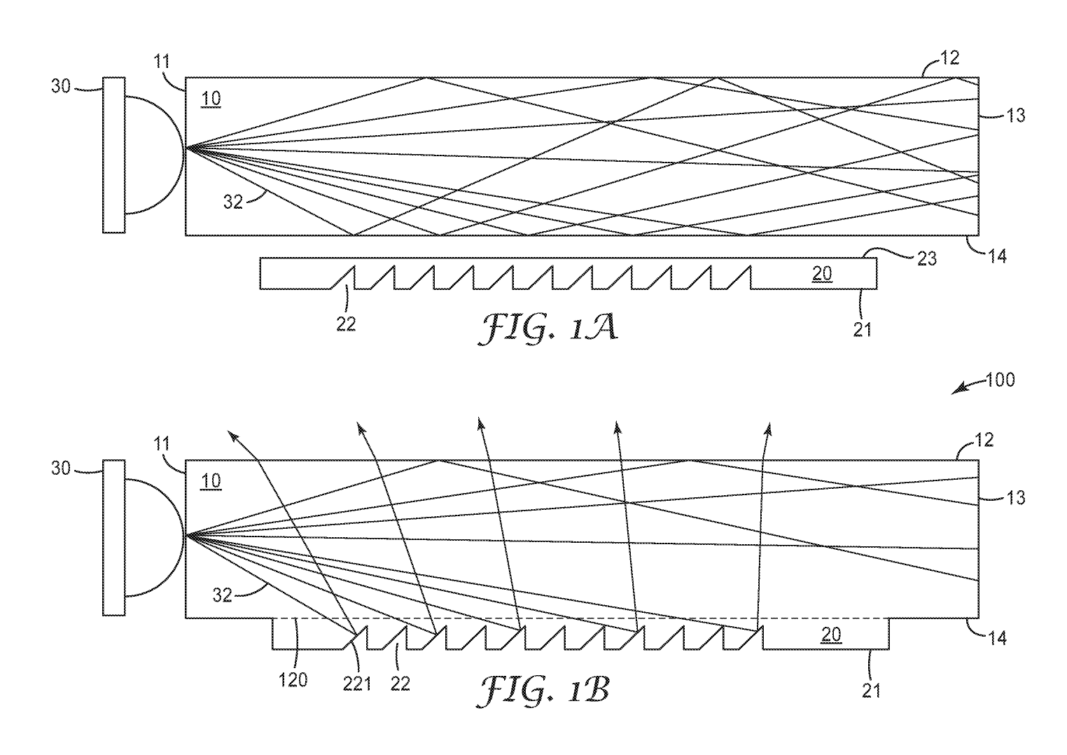

FIG. 1A illustrates a substrate 10 and a structured layer 20 that are separated from each other before assembling to form a lightguide. The substrate 10 has a first major surface 12 and a second major surface 14 opposite the first major surface 12. A light source 30 is disposed adjacent to an edge 11 of the substrate 10 which allows light to be incident into the substrate 10. Incident light 32 from the light source 30 propagates along the substrate 14. Edge-lit lightguides may be arranged with one or more light sources at one or more edges or corners of the lightguide. The light source 30 may be a light emitting diode (LED), fluorescent lamps or other types of lamps. Light output from the light source 30 may be lambertian or other shapes of light output. Light from the light source 30 that is coupled into the receiving edge 11 at a light input location is confined in the substrate 10 by total internal reflection (TIR) as the light propagates away from the light source 30 toward a far edge 13 of the substrate 10.

The substrate 10 can be made of any suitable material that can transmit light. The material may include, for example, polycarbonate, acrylic, glass, etc. In some embodiments, the substrate 10 may be optically transparent. The term “transparent”, “optically transparent” and “optically clear” are used interchangeably and refer to an article (e.g., substrate, film, structured layer, indicia, polymeric composition, adhesive, etc.) that allows a viewer with naked eyes to see through the article. In some embodiments, the article may be made of a material having a high light transmittance (e.g., at least 50 percent, at least 70 percent, at least 90 percent, at least 95 percent, at least 97 percent, at least 98 percent, or at least 99 percent) over at least a portion of the visible light spectrum (about 400 to about 700 nanometers (nm)). In many embodiments, the high transmittance is over the entire visible light spectrum. In other embodiments, the article may not have a high transmittance (e.g., less than 50 percent, 30 percent, or even 10 percent), and a viewer with naked eyes can still see through the article but with a decreased visibility for an ambient image or scene that is behind the article.

The structured layer 20 includes an array of light extractors 22 formed on a structured surface 21 opposite another major surface 23. In some embodiments, the major surface 23 can be an unstructured surface. In other embodiments, the major surface 23 can also be a structured surface. The structured layer 20 may be formed from optically transparent, curable materials, including, for example, acrylates, which can be cured by exposure to ultraviolet (UV) light, or urethane or silicone, which can be cured under heat. In some embodiments, the structured layer 20 can be made of thermoplastic materials such as, for example, polycarbonate or acrylic. In some embodiments, the structured layer 20 can be produced by photopolymerization (e.g., UV) of mixtures of multifunctional thiols and genes.

FIG. 1B illustrates a lightguide 100 including the substrate 10 and the structured layer 20 laminated on the substrate 10. In this embodiment, the structured layer 20 is laminated on the second major surface 14 of the substrate 10. In some embodiments, the refractive index of the structured layer 20 may be the same or higher than the refractive index of the film 10 for coupling light out of the substrate 10. When light 32 is incident on the interface 120 between the substrate 10 and the structured layer 20, at least a portion of the light can be transmitted out of the substrate 10 and into the structured layer 20, rather than being confined within the substrate 10. The light 32 reflects off a reflecting surface 221 of the light extractor 22 and exits transversally from the first major surface 12 of the substrate 10 to provide uniform light extraction from the emitting surface 12. In some embodiments, the light 32 may reflect by total internal reflection at the reflecting surface 221 without a reflective coating (e.g., a metal coating) on the reflecting surface 221.

In the embodiment of FIG. 1B, the light extractors 22 are arranged in an array and have substantially the same orientation. In some embodiments, the orientation of the light extractors 22 may be slightly adjusted so that a majority of the light extractors 22 can directly face the light source 30 to receive and extract incident light as much as possible. For example, the light extractors 22 may be arranged in a curved shape to have the respective reflecting surfaces 221 to directly face the light source 30.

In some embodiments, the light extractors 22 of the structured layer 20 may be substantially the same (e.g., having substantially the same shape, structure and orientation) and are uniformly distributed. In some embodiments, the light extractors 22 may be distributed with a varying area density depending on the distance with respect to a light source.

In some embodiments, the structured layer 20 can be removably laminated on the substrate 10. The terms “removably,” “removable,” or “repositionable” used herein means that the structured layer 20 can be manually removed from the substrate 10 by, for example, peeling, without causing damage to the structured layer 20 and the substrate 10, and the structured layer 20 can be re-laminated onto the substrate 10 after the removal.

In some embodiments, the structured layer 20 can be removably laminated onto the substrate 10 via an adhesive such as, for example, an optically clear adhesive (OCA). The optically clear adhesive can have a refractive index that matches the refractive index of the substrate 10 and the structured layer 20, so as to help coupling light from the substrate 10 into the structured layer 20.

In some embodiments, the optically clear adhesive (OCA) between the substrate 10 and the structured layer 20 may include any relatively soft pressure sensitive adhesive material that is in situ optically clear. That is, the pressure sensitive adhesive material may, itself, not be optically clear in a free standing condition but once incorporated into the laminate can have an optically clear condition and sufficient adhesion to maintain the layers of the laminate in an unaltered form over any of a wide variety of climatic conditions. The pressure sensitive adhesive compositions can be based on acrylate or acrylic copolymers and terpolymers. The thickness of the optically clear adhesive (OCA) may vary, for example, from about 0.1 mil to about 1 mil (0.003 to 0.03 mm).

In some embodiments, the structured layer 20 can be laminated onto the substrate 10 via cling mechanisms without using any additional adhesives or surface treatments. In some embodiments, the structured layer 20 can be made of a sticky material such as, for example, silicone including polydimethylsiloxane (PDMS) that can removably adhere to the substrate surface. The substrate 10 may also be made of a sticky material.

FIG. 1B illustrates the structured layer 20 laminated on the second major surface 14 of the substrate 10. A majority of incident light 32 can be extracted out of the lightguide 100 from the first major surface 12 which is the emitting surface. That is, the structured layer 20 is disposed on the opposite side of the emitting surface 12. It is to be understood that in some embodiments, the structured layer 20 can be directly laminated on the emitting surface 12 to extract light out therefrom. That is, the structured layer 20 can be disposed on the same side of the emitting surface. In some embodiments, the first and second major surfaces 12 and 14 of the substrate 10 each can be laminated with a structured layer, such as the structured layer 20. The location and number of structured layers laminated on the substrate may depend on the specific structure/configuration of the light extractors 22, and the desired effects for viewing when the lightguide 100 is in an on state.

In some embodiments, the structured surface 21 of the structured layer 20 can be laminated onto a major surface of a substrate. When the light extractor 22 is formed as an indentation, air can be trapped in the indentation between the structured layer 20 and the substrate, and a total internal reflection surface can be provided. In some embodiments, the indentations in a selected region can be filled with an optical material to adjust light extraction in the filled region, which will be discussed further below.

In some embodiments, the substrate 10 can be made of a rigid material, and the structured layer 20 can be made of a flexible material that is supported by the rigid substrate 10.

In some embodiments, the substrate 10 can have a thickness, for example, no less than 0.1 mm, no less than 0.5 mm, no less than 1 mm, or no less than 2 mm. A useful thickness range for the substrate 10 may be about 1 to 5 mm, or 2 to 3 mm. The structured layer 20 can have a thickness, for example, no less than 25 microns, no less than 50 microns, or no less than 100 microns. The structured layer 20 may have a thickness no greater than 2 mm, no greater than 1 mm, or no greater than 0.5 mm. The substrate 10 may or may not be thicker than the structured layer 20.

In some embodiments, the lightguide 100 has a thickness that can accommodate the size of a light source such as a LED die to help couple as much light as possible into the lightguide 100. In some embodiments, the lightguide 100 including the laminated substrate 10 and structured layer 20 has a thickness, for example, no less than 1 mm, no less than 2 mm, no less than 3 mm, or no less than 4 mm.

In some embodiments, the substrate 10 can be unstructured, e.g., having unstructured, flat major surfaces 12 and 14, and the structured layer 20 can have at least one of the major surfaces to be structured to form light extractors. In some embodiments, the light extractors can include microstructures (e.g., structures with a major dimension no greater than 1 mm) formed on a film by, for example, microreplication in a roll-to-roll process. The film can have a suitable thickness and flexibility which can be rolled up and easily converted, and then laminated onto the unstructured substrate 10. The laminated structure, i.e., the substrate 10 and the structured layer 20 laminated thereon, can perform as a monolithic lightguide that may not otherwise be produced by a roll-to-roll process due to its thickness or rigidity not able to roll up onto a core.

In some embodiments, the substrate 10 and the structured layer 20 can be made of the same or different optically transparent material(s). The laminated lightguide stack can be optically transparent in an off state.

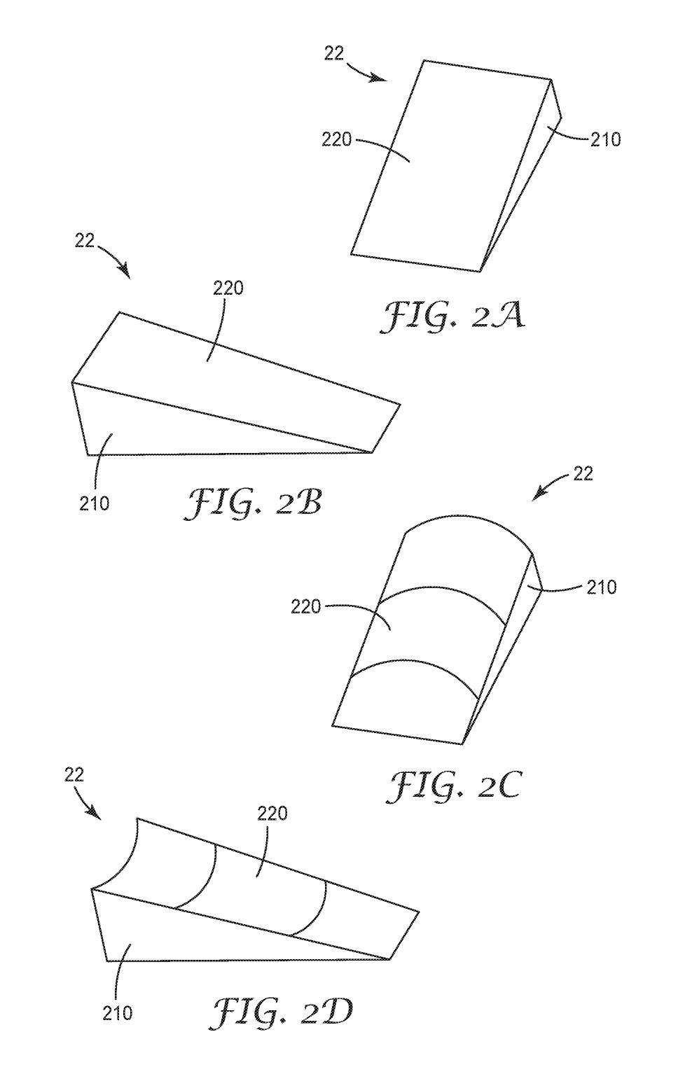

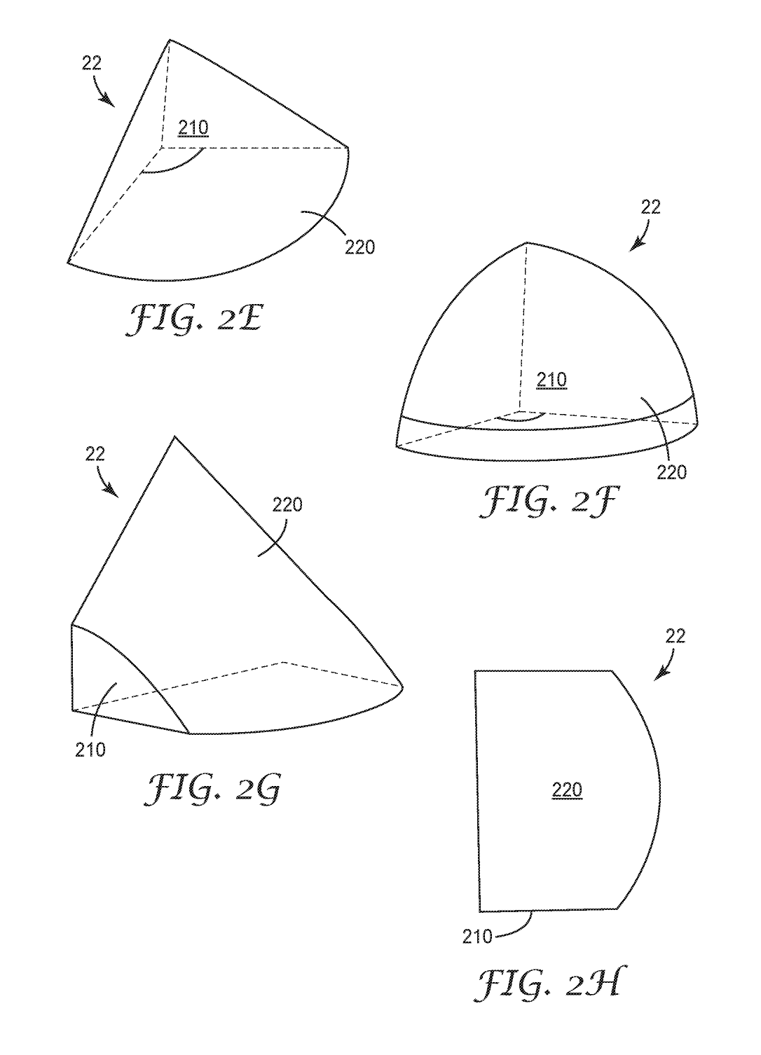

FIGS. 2A-2H illustrate exemplary light extractors 22. The light extractor 22 includes one or more side walls 210 and one or more inclined walls 220. In some embodiments, the light extractor 22 may include two side walls, and in some embodiments even more. In some embodiments, the light extractor 22 can be substantially wedge shaped, as depicted in FIGS. 2A-2D. In some embodiments, the light extractor 22 can be substantially partial cone shaped, as depicted in FIG. 2E. In some embodiments, the light extractor 22 can be substantially partial sphere shaped, as depicted in FIG. 2F. In some embodiments, the light extractor can be a trimmed partial cone, as depicted in FIGS. 2G and 2H.

In some embodiments such as shown in FIGS. 1A-B, the light extractor 22 is formed as an indentation in the otherwise solid film 10 (an “innie” structure), obviating the need for a bottom wall. The light extractor 22 may have side walls that are parallel or non-parallel. Each of one or more side walls 210 may be substantially planar or may be at least partially curved or faceted. Each of one or more side walls may be perpendicular to a plane of the lightguide or form an angle of 10 degrees or less with a plane perpendicular to the plane of the lightguide. For lightguides that are curved, non-planar, shaped, or molded, the plane of the lightguide may be a local tangent plane at the location of the lightguide. The light extractor 22 may further include a back wall and a bottom wall. The inclined wall 220 may be substantially flat or planar or it may include negative or positive cylindrical sag. In this case, the inclined wall 220 may have a curved shape or surface in one direction but not along a second, orthogonal direction. In some embodiments, the light extractor may be truncated (i.e., it may not fully taper to an edge).

The light extractor 22 may also have any suitable size. In some embodiments, light extractor 22 may be characterized by its projected area onto a lightguide. In some embodiments, the projected area of light extractor 22 may be substantially square or rectangular. In some embodiments, a maximum dimension of the projected area of light extractor 22 may be no greater than 850 microns. In some embodiments, a minimum dimension of the projected area of light extractor 22 may be no less than 20 microns. In some embodiments, a maximum dimension of the projected area of light extractor 22 can be less than 1000, 500, or 200 microns. In some embodiments, a minimum dimension of the projected area of light extractor 22 can be no less than 5, 10, or 20 microns.

The light extractor 22 may be configured to preferentially extract light within a range of extraction directions, which may correspond to certain viewing angles. For example, the inclined wall 220 may affect the range of angles extracted light travels along once extracted from a lightguide. Given the light extractor shape and the refractive index differences between the light extractor (air if an indentation in an otherwise solid lightguide) and the lightguide, it is possible to model and predict the interaction of light with the faces of light extractor 22.

In some embodiments, the light extractors 22 may be high efficiency light extractors. High efficiency may be defined as the ratio of light incident on a light extractor to light extracted by the light extractor. This efficiency can be affected mostly by shape and by the refractive index difference between the light extractor and the lightguide.

In some embodiments, extractor efficiency may also be directional dependent. For the exemplary extractor shapes depicted in FIGS. 2A-2H, the light extractor may have a first extraction efficiency for light incident on the inclined wall 220, and a second extraction efficiency for light incident on one or more side walls 210, and the first extraction efficiency may be significantly higher than the first extraction efficiency. Direction-dependent light extractors are described in more detail in the co-owned Provisional Patent Application No. 61/922,217, filed on Dec. 31, 2013 and titled, “Lightguide Including Extractors with Directionally Dependent Extraction Efficiency.”

While FIGS. 2A-H illustrate substantially wedge shaped, partial cone or sphere shaped light extractors, it is to be understood that light extractors described herein can be any geometric configurations or surface profiles (including, for example, protruding and recessed structures). Geometric configurations of light extractors can include, for example, cones, aspheres, truncated aspheres, and truncated cones, where “truncated” configurations have both a base and a second truncation that can form a planar top surface. The light extractors can include such structural elements as a base, one or more faces (for example, that form a side wall), and a top (which can be, for example, a planar surface (for example, formed by truncation) or even a point). Such elements can be of essentially any shape (for example, bases, faces, and tops can be circular, elliptical, or polygonal (regular or irregular), and the resulting side walls can be characterized by a vertical cross section (taken perpendicular to the base) that is parabolic, hyperbolic, or linear in nature, or a combination thereof). In some embodiments, the side wall may not perpendicular to the base of the structure (for example, vertical tangent angles at the base of about 10 degrees to about 80 degrees (preferably, about 20 to about 70; more preferably, about 30 to about 60) can be useful). Light extractors can have a principal axis connecting the center of its top with the center of its base. Tilt angles (the angle between the principal axis and the base) of up to about 80 degrees (preferably, up to about 25 degrees) can be achieved, depending upon the desired brightness and field of view. In some embodiments, the light extractor 22 can be a prism such as, for example, a pyramid. In some embodiments, the light extractor 22 can be a truncated prism.

Light extractors described herein may be formed by any suitable method and can be formed at the same time or process as a film such as the structured layer 20 of FIG. 1A. For example, a substantially planar lightguide may have an extractor mold replicated into one or both of its major surfaces. This may be done through any suitable replication tool or master include the surface negative of the desired structure (whether the extractors are protruding or are recessed), such as a metal or silicone tool fabricated through any suitable process. Particularly for the small sizes of extractors herein, a master utilizing a multi-photon (or, specifically, two-photon) photolithographic process which is described in, for example, U.S. Pat. No. 7,941,013 (Marttila et al.), which has been incorporated by reference herein. The multi-photon photolithographic process involves imagewise exposing at least a portion of a photoreactive composition to light sufficient to cause simultaneous absorption of at least two photons, thereby inducing at least one acid- or radical-initiated chemical reaction where the composition is exposed to the light, the imagewise exposing being carried out in a pattern that is effective to define at least the surface of a plurality of light extraction structures. The lightguide may be cast against the master or replication tool and subsequently cured or hardened.

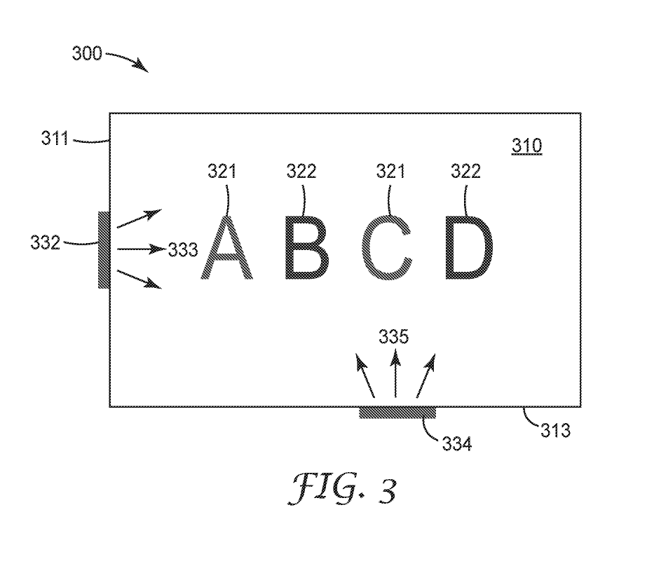

FIG. 3 illustrates a lightguide 300 including a substrate 310 and one or more indicia laminated onto one or more major surfaces of the substrate 310. The indicia 321 and 322 can be cut out of the same structured film including light extractors such as the structured layer 20 of FIG. 1A. In some embodiments, the indicia can be cut out of different structured films. The indicia can be, for example, words, letters, numbers, or other indicia, such as a logo or a trademark. Each of the indicia includes a group of light extractors such as the light extractor 22. In some embodiments, within the same indicium, the light extractors may have substantially the same shape, structure, and orientation, and the light extractors can be uniformly distributed therein. In some embodiments, within the same indicium, the light extractors may have varied orientations to maximize light extraction from a light source. In some embodiments, within the same indicium, the light extractors may be distributed with varied area density to provide uniform light extraction.

The substrate 310 can be, for example, the substrate 10 of FIG. 1A, and the indicia can be laminated on the second major surface 14 of the substrate 10. The lightguide 300 further includes a first light source 332 disposed adjacent to an edge 311 of the substrate 310, and a second light source 334 disposed adjacent to another edge 313 of the substrate 310. Light from the first and second light sources 332 and 334 propagate along the substrate 310 with different optical paths 333 and 335, respectively.

In the indicia as depicted in FIG. 3, a first indicium 321 (e.g., letter “A” or “C”) includes a first group of light extractors having a first general orientation. For example, the light extractors of the first indicium 321 each may include a reflecting surface, for example, the reflecting surface 221 of FIG. 1B or the inclined wall 220 of FIGS. 2A-H, which generally faces the first light source 332 to primarily extract light 333 out of the lightguide 300 in a transversal direction, e.g., from the perspective in FIG. 3, likely into or out of the page. A second indicium 322 (e.g., letter “B” or “D”) includes a second group of light extractors having a second general orientation. For example, the light extractors of the second indicium 322 each may include a reflecting surface, for example, the reflecting surface 221 of FIG. 1B or the inclined wall 220 of FIGS. 2A-H, which generally faces the second light source 334 to primarily extract light 335 out of the lightguide 300 in the same or different transversal direction. It is to be understood that any numbers of indicia can be used with suitable orientations.

In some embodiments, the light sources 332 and 334 can emit light with different colors, e.g., red and green. The light extractors of the first indicium 321 can primarily extract red light from the first light source 332 instead of the green light from the second light source 334, and the letters “A” and “C” may appear red for viewing when the lightguide 300 is in an on state (e.g., when the light sources 332 and 334 are on). The light extractors of the second indicium 322 can primarily extract green light from the second light source 334 instead of the red light from the first light source 332, and the letters “B” and “D” may appear green for viewing when the lightguide 300 is on.

In some embodiments, at least some of the indicia can be removably and repositionably laminated onto the substrate 310. In some embodiments, the orientation of the light extractors of the respective indicia can be adjusted by rotation with respect to the light sources 332 and 334. For example, the letter “A” can be peeled away from the substrate 310, in-plane rotate 90 degrees, and re-laminated onto the substrate 310 to have the light extractors thereof oriented to primarily extract light 335 from the second light source 334 instead of light 333 from the first light source 332. In this manner, the color and luminescence of the letter “A” can be adjusted. For example, the color of letter “A” can change from red to green after the rotation. It is to be understood that any number of light sources with desired colors can be used for appropriately oriented one or more indicia.

In some embodiments, the material of indicia and the substrate may have substantially the same optical appearance, and when the lightguide 300 is in an off state, the indicia laminated on the substrate 310 (e.g., 321 and 322 shown in FIG. 3) can be visually indiscernible from the substrate. In some embodiments, the substrate and indicia can be made of optically transparent materials, and the lightguide 300 may allow clear and undistorted viewing of an ambient image or scene behind the lightguide 300.

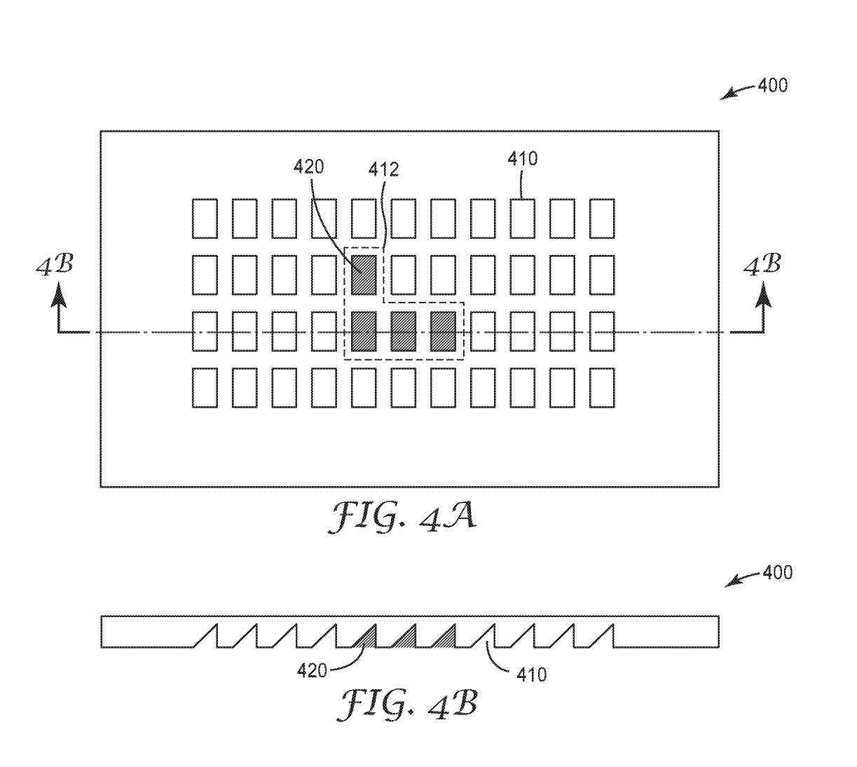

FIG. 4A-B illustrate a structured film 400 including an array of light extractors 410 formed on a major surface thereof. Light extractors in a region 412 are selectively filled with an optical material 420 to adjust or modify light extraction in the region 412. In some embodiments, the optical material 420 can be an optical clear material having a refractive index which is substantially the same or close to that of the material of the film 400. After filling the region 412 with the optical material 420, the light extractors in the region 412 may not act as a light extractor anymore or not as efficient as the light extractors in adjacent regions in terms of light extraction. This allows light extraction in the region 412 to be adjusted/modified compared to adjacent regions. When the optical material 420 has a refractive index substantially matching that of the film 400, light extraction in the region 412 can be substantially blocked, while light extractors in regions of the film 400 adjacent to the filled region 412 may not be affected in terms of light extraction. In this manner, a pattern such as the “L” shaped region 412 shown in FIG. 4A, can be formed when the film 400 is in an on state.

In some embodiments, the optical material 420 and the material of the film 400 may have substantially the same optical appearance, and when the film 400 acts as a lightguide which is in an off state, the filled region 412 may be visually indiscernible from adjacent regions of the film 400. In some embodiments, the optical material and the film 400 may be made of the same or different optically transparent materials, and the lightguide 400 may allow clear and undistorted viewing of an ambient image or scene behind the lightguide 400.

In some embodiments, the structured film 400 can be removably laminated onto a substrate such as the substrate 10 of FIG. 1A to form a lightguide. In other embodiment, the structured film 400 itself can be a monolithic lightguide. One or more light sources can be provided to emit light into the structured film 400. Incident light propagates along the structured film 400 can be selectively extracted out of the film 400 in different regions, and a pattern, e.g., “L” as depicted in FIG. 4A can appear for viewing.

In some embodiments, a customized pattern can be formed on the structured film 400 by selectively filling the region 410 by, for example, an ink-jet process. The optical material 420 can be any suitable inkjetable materials. The filled optical material may be thermally or optically cured or dried after filling. In some embodiments, the suitable inkjetable material may include a typical ink-jet sol for an ink-jet process. One exemplary sol can be prepared by mixing a pre-hydrolyzed silane in a solvent (e.g., water) with an appropriate concentration to obtain a desired viscosity and surface tension. One or more photostarter materials can be added to help polymerization of the ink-jet sol by, for example, UV light irradiation.

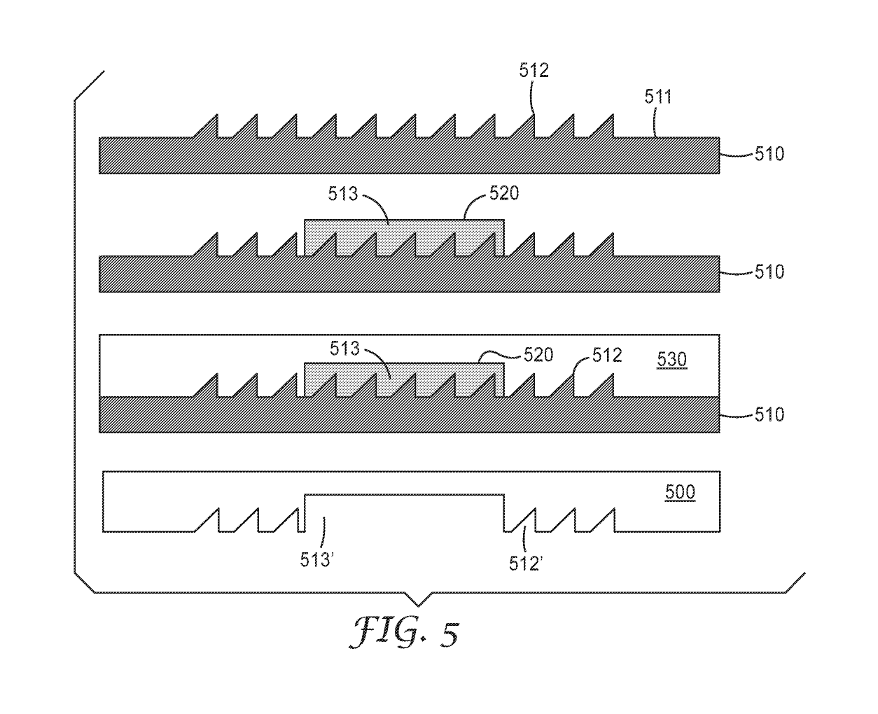

FIG. 5 illustrates a process of producing a structured film 500. A tool 510 is provided with structures 512 on a surface 511 thereof. The tool 510 can be made of, for example, nickel. A blocking material 520 is applied onto the surface 511 to change the topography in a selected region 513. The blocking material 520 can be applied by, for example, an ink-jet process. By controlling the inkjet pattern coated on the surface 511, a custom image can be created in a final light extraction film to be produced. It is to be understood that any suitable block material can be applied by appropriate processes onto the tool 510 in a selected region. A film making material 530 is then applied to the surface 511. The film making material 530 can be dried or cured to form the structured film 500 including light extractors 512′ corresponding to the structures 512 of the tool 510. The structured film 500 can use the same material as the structured layer 20 of FIG. 1A. In a region 513′ of the film 500 corresponding to the region 513 of the tool 510, light extractors may not form due to the presence of the blocking material 520 in the region 513. The blocking material 520 can be removable from the tool 510. In some embodiments, the blocking material can include a water-soluble polymer such as, for example, polyvinyl alcohol (PVA) that can be washed away from the tool 510 by water.

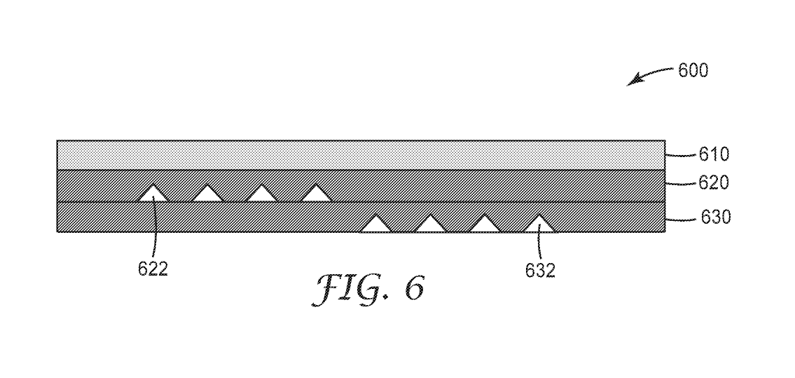

FIG. 6 illustrates a lightguide 600 including a substrate 610 and structured films 620 and 630 laminated thereon. The structured films 620 and 630 include light extractors 622 and 632, respectively, to direct light out of the lightguide 600. The structured films 620 and 630 are arranged such that the light extractors 622 and 632 can form a desired pattern for viewing when the lightguide 600 is in an on state. In some embodiments, the light extractors in at least one of the films can include one or more direction-dependent light extractors as discussed above. For example, the light extractors 622 of the structured film 620 can extract light from a first light source out of the lightguide 600, and the light extractors 632 of the structured film 630 can extract light from a second light source, where the first and second light sources emit light along different ranges of optical path. It is to be understood that three or more structured films can be laminated on one or both major surfaces of the substrate 610 to provide desired patterns.

Various embodiments are provided that are lightguides, and methods of making and using the lightguides.

Embodiment 1 is a lightguide comprising:

a substrate having a first major surface and a second major surface opposite the first major surface, the substrate including one or more edges being configured to allow light to be incident into the substrate and propagate along the substrate, the first and second major surfaces being capable of confining the light in the substrate primarily by total internal reflection; and

one or more structured layers laminated on at least one of the first and second major surfaces of the substrate, the structured layers each including one or more light extractors being configured to direct the light out of the lightguide from an emitting surface thereof, the one or more structured layers being removable from and repositionable on the substrate.

Embodiment 2 is the lightguide of embodiment 1, wherein the one or more light extractors comprise at least one direction-dependent light extractor having an inclined surface to extract incident light.
Embodiment 3 is the lightguide of embodiment 1 or 2, wherein the one or more structured layers each have a structured surface, and an unstructured surface opposite the structured surface, the light extractors are formed on the structured surface, and the unstructured surface is laminated on the second major surface of the substrate.
Embodiment 4 is the lightguide of embodiment 3, wherein the light extractors extract light out of the lightguide from the first major surface of the substrate.
Embodiment 5 is the lightguide of any one of embodiments 1-4, wherein at least one of the light extractors has a partial cone or sphere shape.
Embodiment 6 is the lightguide of any one of embodiments 1-5, being optically transparent in an off state.
Embodiment 7 is the lightguide of any one of embodiments 1-6, wherein the one or more structured layers are removably laminated onto the substrate with an optically clear adhesive (OCA).
Embodiment 8 is the lightguide of any one of embodiments 1-6, wherein the one or more structured layers are removably laminated onto the substrate via a cling mechanism without using an adhesive.
Embodiment 9 is the lightguide of any one of embodiments 1-8, wherein the one or more structured layers are in the form of one or more discrete indicia for viewing when the lightguide is in an on state.
Embodiment 10 is the lightguide of embodiment 9, wherein the indicia each include a group of light extractors that have substantially the same structure and are uniformly distributed therein.
Embodiment 11 is the lightguide of embodiment 9 or 10, wherein the indicia each include a group of light extractors have substantially the same general orientation.
Embodiment 12 is the lightguide of embodiment 9 or 10, wherein the indicia each include a group of light extractors have varied orientations.
Embodiment 13 is the lightguide of embodiment 9, 10 or 11, wherein a first indicium in the indicia includes a first group of extractors having a first general orientation, and a second indicium in the indicia includes a second group of extractors having a second general orientation different from the first general orientation.
Embodiment 14 is the lightguide of embodiment 13, further comprising a first light source to emit light into the substrate along a first range of optical path, and a second light source to emit light into the substrate along a second range of optical path, wherein the first group of extractors primarily extract light from the first light source, and the second group of extractors primarily extract light from the second light source.
Embodiment 15 is a lightguide comprising:

a structured layer having a structured surface and an array of light extractors formed on the structured surface to direct light out of the lightguide from an emitting surface thereof,

wherein the structured surface of the structured layer includes a first region and an adjacent second region, and the light extractors in the first region are filled with an optical material, the optical material being configured to adjust light extraction in the first region compared to that in the second region when the lightguide is in an on state.

Embodiment 16 is the lightguide of embodiment 15, wherein the optical material includes an optical clear material having a refractive index matching that of the structured layer to substantially block light extraction.
Embodiment 17 is a method of making a lightguide, comprising:

providing a substrate having a first major surface and a second major surface opposite the first major surface, the substrate including one or more edges being configured to allow light to be incident into the substrate and propagate along the substrate, the first and second major surfaces being capable of confining the light in the substrate primarily by total internal reflection; and

laminating one or more structured layers onto at least one of the first and second major surfaces of the substrate, the one or more structured layers each including one or more light extractors being configured to direct the light out of the lightguide from an emitting surface thereof, the one or more structured layers being removable from and repositionable on the substrate.

Embodiment 18 is a method comprising:

providing one or more structured layers, the one or more structured layers each including an array of light extractors formed on a structured surface thereof;

cutting one or more indicia out of the one or more structured layers; and

laminating the one or more indicia onto a major surface of a substrate,

wherein the indicia are configured to extract light that is otherwise confined in and propagates in the substrate.

Embodiment 19 is the method of embodiment 18, wherein a first indicium in the indicia includes a first group of extractors having a first general orientation, and a second indicium in the indicia includes a second group of extractors having a second general orientation different from the first general orientation.
Embodiment 20 is a method of producing a lightguide comprising:

providing a structured layer, the structured layer including an array of light extractors formed on a structured surface thereof, the array of light extractors being configured to extract light out of the lightguide; and

selectively filling a first group of light extractors in a first region of the structured surface with an optical material, the optical material being configured to modify light extraction in the first region when the lightguide is in an on state.

Embodiment 21 is a method comprising:

providing a tool including an array of structures on a major surface thereof;

selectively filling a first region of the major surface of the tool with a blocking material;

providing a film forming composition on the major surface of the tool to form a structured layer, wherein an array of light extractors are formed on a structured surface of the structured layer except for a first region thereof corresponding to the first region of the tool; and

removing the structured layer from the tool, the structured layer having the structured surface including the light extractors.

Embodiment 22 is the method of embodiment 21, further comprising removing the blocking material from the tool.

Descriptions for elements in figures should be understood to apply equally to corresponding elements in other figures, unless indicated otherwise. The present disclosure should not be considered limited to the particular embodiments described above, as such embodiments are described in detail in order to facilitate explanation of various aspects of the disclosure. Rather, the present disclosure should be understood to cover all aspects of the disclosure, including various modifications, equivalent processes, and alternative devices falling within the scope of the disclosure as defined by the appended claims and their equivalents.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Example 1

A lightguide having a configuration similar to the lightguide 100 of FIG. 1B was made. A silicone light extractor film including an array of wedge shaped light extractors was provided. The silicone light extractor film had a thickness of about 1 mm. The light extractor film was laminated to a 3.3 mm thick substrate by cling forces to form a lightguide stack. The substrate was made of optically clear, unstructured acrylic. The light extractor film was removable from the substrate. Three red LEDs were coupled into the lightguide stack from an edge of the substrate. Red light from the LEDs was extracted out of the substrate by the light extractors of the laminated silicone film. The light extractors in this example had a wedge shape that originated from a tool made by two-photon mastering where the structures on the tool were 45 degree wedges. The light extractors were “innie” structures, on the bottom surface of the silicone light extractor film. The lightguide stack was optically transparent in an off state.

### Example 2

A lightguide having a configuration similar to the lightguide 300 of FIG. 3 was made. Indicia with different shapes (e.g., letters) were cut out of a 1 mm thick structured film. The indicia were subsequently laminated to a 3.3 mm thick acrylic sheet to create a custom text image on the sheet surface. In this example, the light extractors in the respective indicia were oriented differently for each letter to accept light from one or the other of two LED sources. Nine red LEDs were coupled into the top side of the lightguide, while an array of 9 green LEDs were coupled in parallel along the bottom of the lightguide. The result was a customized light guide with alternating red and green letters to create the word “CHRISTMAS” when the lightguide was in an on state. The lightguide was optically transparent in an off state where the word “CHRISTMAS” was visually indiscernible from the substrate and a viewer could see through the lightguide.

### Example 3

A lightguide was produced by a process similar to the process shown in FIG. 5. A tool was modified with a Poly Vinyl Alcohol (PVA) coating to prevent formation of light extractors in a selected region of the tool. The tool including microstructures was made of nickel. Liquid PVA was coated by a pipette onto the nickel surface and allowed to dry down to form a pattern. A UV cured acrylic film was made from the PVA coated tool, resulting in a microreplicated lightguide film with the pattern cast into the tool in such a way as to mask the extraction features in those areas.

1. A lightguide comprising:
a substrate having a first major surface and a second major surface opposite the first major surface, the substrate including one or more edges being configured to allow light to be incident into the substrate and propagate along the substrate, the first and second major surfaces being capable of confining the light in the substrate primarily by total internal reflection; and
one or more structured layers laminated on at least one of the first and second major surfaces of the substrate, the structured layers each including one or more light extractors being configured to direct the light out of the lightguide from an emitting surface thereof, the one or more structured layers being removable from and repositionable on the substrate.

2. The lightguide of claim 1, wherein the one or more light extractors comprise at least one direction-dependent light extractor having an inclined surface to extract incident light.

3. The lightguide of claim 1, wherein the one or more structured layers each have a structured surface, and an unstructured surface opposite the structured surface, the light extractors are formed on the structured surface, and the unstructured surface is laminated on the second major surface of the substrate.

4. The lightguide of claim 3, wherein the light extractors extract light out of the lightguide from the first major surface of the substrate.

5. The lightguide of claim 1, wherein at least one of the light extractors has a partial cone or sphere shape.

6. The lightguide of claim 1, being optically transparent in an off state.

7. The lightguide of claim 1, wherein the one or more structured layers are removably laminated onto the substrate with an optically clear adhesive (OCA).

8. The lightguide of claim 1, wherein the one or more structured layers are removably laminated onto the substrate via a cling mechanism without using an adhesive.

9. The lightguide of claim 1, wherein the one or more structured layers are in the form of one or more discrete indicia for viewing when the lightguide is in an on state.

10. The lightguide of claim 9, wherein the indicia each include a group of light extractors that have substantially the same structure and are uniformly distributed therein.

11. The lightguide of claim 9, wherein the indicia each include a group of light extractors have substantially the same general orientation.

12. The lightguide of claim 9, wherein a first indicium in the indicia includes a first group of extractors having a first general orientation, and a second indicium in the indicia includes a second group of extractors having a second general orientation different from the first general orientation.

13. The lightguide of claim 12, further comprising a first light source to emit light into the substrate along a first range of optical path, and a second light source to emit light into the substrate along a second range of optical path, wherein the first group of extractors primarily extract light from the first light source, and the second group of extractors primarily extract light from the second light source.

14. A lightguide comprising:
a structured layer having a structured surface and an array of light extractors formed on the structured surface to direct light out of the lightguide from an emitting surface thereof,
wherein the structured surface of the structured layer includes a first region and an adjacent second region, and the light extractors in the first region are filled with an optical material, the optical material being configured to adjust light extraction in the first region compared to that in the second region when the lightguide is in an on state.

15. The lightguide of claim 14, wherein the optical material includes an optical clear material having a refractive index matching that of the structured layer to substantially block light extraction.

16. (canceled)

17. A method comprising:
providing one or more structured layers, the one or more structured layers each including an array of light extractors formed on a structured surface thereof;
cutting one or more indicia out of the one or more structured layers; and
laminating the one or more indicia onto a major surface of a substrate,
wherein the indicia are configured to extract light that is otherwise confined in and propagates in the substrate.

18. The method of claim 17, wherein a first indicium in the indicia includes a first group of extractors having a first general orientation, and a second indicium in the indicia includes a second group of extractors having a second general orientation different from the first general orientation.

19-21. (canceled)
